(19) United States
(12) Patent Application Publication
(10) Pub. No.: US 2017/0282188 A1
(43) Pub. Date: Oct. 5, 2017

(54) Apparatus and method for using a tip collar on a single row of pipette tips

(71) Applicant: Felix H. Yiu, Covina, CA (US)

(72) Inventor: Felix H. Yiu, Covina, CA (US)

(21) Appl. No.: 14/452,447

(22) Filed: Aug. 5, 2014

(51) Int. Cl. B01L 9/00; B01L 3/02

(52) U.S. Cl. CPC B01L 9/543; B01L 3/0275; B01L 2200/025

(57) ABSTRACT

An apparatus for assembling together a plurality of pipette tips into a single line using a tip collar that will provide structural rigidity to the plurality of pipette tips and the method of incorporating such an apparatus. Such rigidity created by the tip collar apparatus will allow for an innovative method of connecting a single line of pipette tips to their respective pipettors that will reduce the amount of downward axial force required to impinge the plurality of pipette tips using the traditional connection method. The tips will be maintained in a consistent and straight pattern as required for pipetting, and not susceptible to breakage. The tips can also be customized by the user into any pattern of tips in a single line as needed for specialized applications.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is used in the field of small volume liquid pipetting using the air displacement pipetting technique. These air displacement pipettors are used to pipette or aspirate and dispense (transfer) small volumes of liquid, a typical volume range being 1 microliter to 1 milliliter of liquid. A common method for containing the liquid is to use a disposable pipette tip to hold the liquid after it is aspirated and before it is dispensed. The most common material to produce the pipette tips is polypropylene. The advantage of a disposable pipette tip in comparison to a reusable fixed tip is that the liquid being pipetted only comes into contact with the disposable tip, which is discarded after each use thus preventing any carryover or sample-to sample contamination in between pipetting operations. The reusable fixed tips must be washed in between each pipetting operation, and even the washing protocol does not guarantee complete elimination of carryover. Because of this the use of disposable pipette tips is very common for this application.

Air displacement pipettors can be constructed to pipette one liquid sample at a time, or more than one. When more than one sample is pipetted at the same time, this is commonly referred to as a multichannel pipettor. Commonly available multichannel air displacement pipettors may use a number of disposable tips arranged in a single row, or a number of pipette tips arranged in a grid fashion (array pattern). It is a standard in the industry to pipette to and from microtiter plates that have an industry-accepted spacing of liquid containers, or wells. These microtiter plates, also called microplates, commonly have 96 wells arranged in an 8×12 grid or 384 wells arranged in a 16×24 grid. The spacing between wells is defined by the industry-accepted standard. This allows multichannel air displacement pipettors to be constructed that are able to access multiple wells all at once for pipetting, either in a single row or as a grid.

In the current art it is common to package pipette tips either loose-packed or in racks. When packaged as loose-packs, a large number of individual pipette tips are placed into a bag. This is the most economical way of packaging disposable pipette tips, but it requires extra work for the operator because the tips must be individually removed from the bag and placed into some sort of holder or rack in order to be loaded onto the pipettor. Because of this, the more common method is to supply the tips in racks, which provide more convenience and ease of use for the operator since they are ready to be loaded into the pipettor. Because of the industry standard of pipetting into microplates, the commonly available racks of tips are in the 8×12 format for 96 total tips or 16/24 format for 384 total tips. These provide a convenient system for loading tips onto the pipettor in batches of 96 or 384.

It is common in the industry to perform an experiment known as a serial dilution. When performing the serial dilution experiment, it is necessary to pipette to a subset of the wells on the microplate rather than the entire microplate at once. The most common application of the serial dilution process for microplates is to pipette to one row or column of wells at a time. For a 96 well microplate this means using 8 tips to pipette to a column or 12 tips to pipette to a row. For a 384 well microplate this means using 16 tips to pipette to a column or 24 tips to pipette to a row. In the current art various methods are used to load a single line of pipette tips. For manual handheld pipettors the common practice is for the operator to manually load the tips by positioning the pipettor over a single line of tips in the rack of 96 or 384, and to manually apply downward force to load the tips onto the pipettor. For automated motor-driven pipettors, various types of adaptors are used so that a single line of tips can be loaded onto the head. These adaptors require the operator to manually load the individual tips into the adaptor one at a time, either from a loose-pack bag or from a rack of 96 or 384 tips.

The prior art methods of loading a single line of pipette tips have a number of limitations.

One limitation is that if the operator must load the tips manually from either a loose pack or a rack of tips, it is a tedious process to load the single row of tips onto the pipettor.

Another limitation is that it is difficult for the operator to load all of the tips in the single line is a consistent fashion as far as the straightness of the tip alignment to the vertical axis and the depth to which the tips are installed. If the tips are not in the best possible alignment with each other, the quality of the pipetting results (accuracy and precision) can be negatively affected.

Yet another limitation is that if the operator must manually handle the tips in order to load them onto the pipettor, the tips may be contaminated by this manual handling steps. Such contamination can affect the quality of the scientific methods or assays for which the pipettor is used for.

Yet another limitation is that considerable force is required to load the single line of pipette tips. If the tips are being loaded manually then there is risk or repetitive stress injury for the operator. If the tips are being loaded using a motorized mechanism then a more complex and expensive mechanism is required in order to reliably load the tips onto the pipettor.

Yet another limitation is that prior art which uses a single row of pipette tips manufactured as a single assembly cannot be customized with varying numbers of tips. This is often a requirement for specialized liquid handling operations.

The present invention is a novel design that addresses the shortcomings of the current art when performing serial dilutions with air displacement pipetting. The tips are packaged in a single file in a ready-to-use format. The single file tip collars are organized into a rack for the convenience of the operator. The design of the collar is such that a single line of tips can be loaded onto either a manually-operated handheld pipettor or an automated motor-driven operator with an easy operation requiring less force than the current art.

### BRIEF SUMMARY OF THE PRESENT INVENTION

The present invention is a tip collar that is used to contain a plurality of disposable pipette tips to be used on a multichannel air displacement pipettor. The plurality of tips is be arranged in a single line pattern suitable for pipetting using the serial dilution method or any other method that can benefit from this tip arrangement.

It is an objective of the invention to create a unitary entity between a single line of multiple pipette tips and a tip collar that provides structural rigidity to allow for ease of installation between the assembly set of pipette tips and a pipetting head adaptor.

It is another objective of the invention to create an assembly set of a single line of pipette tips that is easily adaptable to fit onto an automated pipettor machine or onto a manually-operated pipettor.

It is yet another objective of the present invention to provide a complete assembly set of pipette tips that can be easily and economically disposable.

It is yet another objective of the present invention to create an apparatus for assembling multiple pipette tips that is lower in manufacturing costs than current designs.

It is yet another objective of the present invention to utilize the tip collar to greatly reduce the amount of force that is required to create a seal between a pipette tip and a pipettor.

It is yet another objective of the present invention to reduce the amount of force that is required to eject the pipette tips from the respective pipettors.

It is yet another objective of the present invention to create a seal at the top surface of the pipette tips when connected to a pipettor using a gasket mating instead of through interference within the internal walls of the open proximal end of the pipette tips.

It is yet another objective of the present invention to allow a seal to be created using an upward lifting force instead of a downward impinging axial force.

It is yet another objective of the present invention to allow a pipettor to connect to a plurality of pipette tips without breaking the pipette tips.

These and other advantages and features of the present invention are described with specificity so as to make the present invention understandable tone of ordinary skill in the art.

### BRIEF DESCRIPTION OF SEVERAL VIEWS OF THE DRAWINGS

FIG. 1 is a side elevation and cutaway view showing the current invention in one embodiment where self-sealing pipette tips are installed from the bottom, prior to the tips being installed.

FIG. 2 is a side elevation and cutaway view showing the current invention in one embodiment where self-sealing pipette tips are installed from the bottom, after the tips have been installed.

FIG. 3 is a side elevation and cutaway view showing the current invention in one embodiment where internally sealed pipette tips are installed from the top, prior to the tips being installed.

FIG. 4. is a side elevation and cutaway view showing the current invention in one embodiment where internally sealed pipette tips are installed from the top, after the tips have been installed.

FIG. 5 is a perspective view showing the current invention as it is packaged for use.

FIG. 6A is a perspective view showing the current invention in one embodiment, where the tips are installed from the bottom, and illustrating how the number of the tips that is loaded is independently controlled by the user.

FIG. 6B is a perspective view showing the current invention in one embodiment, where the tips are installed from the top, and illustrating how the number of the tips that is loaded is independently controlled by the user.

### DETAILED DESCRIPTION OF THE INVENTION

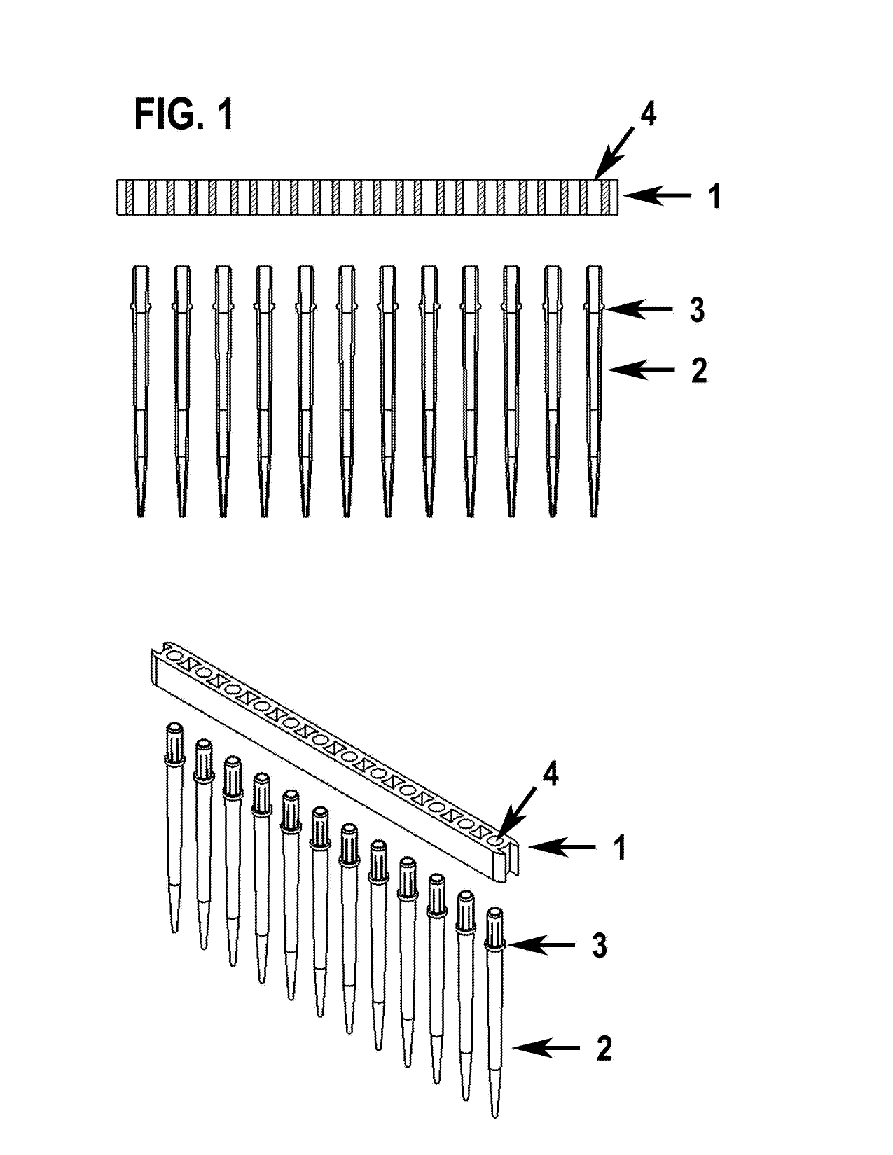

FIG. 1 gives a side elevation view and perspective view of the current invention with the single line of pipette tips. The tip collar 1 will be connected to a plurality of pipette tips 2. The tip collar 1 here is shown in position prior to being connected to the plurality of pipette tips 2 to provide structural rigidity to the pipette tips. In this exemplary embodiment using EZ-Load (EZL) tips, the bottom surface of the tip collar 1 sits on top surface of the shoulder flanges 3 of the plurality of pipette tips 2 to provide the desired structural rigidity. The tip collar 1, in the current exemplary embodiment is made out of a plastic material; however, the tip collar 1 can be made out of metal, aluminum, carbon fiber, or any other material that is capable of providing the desired structural rigidity without departing from the scope of the present invention. Furthermore, the tip collar 1 is currently shown to be in a rectangular shape in order to accommodate the plurality of pipette tips; however, the tip collar 1 can be in a square shape, triangular shape, circular shape, oval shape, or any other shape that is capable of assembling together the plurality of pipette tips without departing from the scope of the present invention. Axially placed holes 4 are placed on the tip collar 1 to allow the plurality of pipette tips 2 to be connected to the tip collar 1. Here, in the current exemplary embodiment, the axially placed holes 4 are arranged in a single line of 12 tips 2; however axially placed holes 4 can be arranged in a single line of 4, 8, 16, or 24 or any other number that allows for connection with corresponding pipette tips 2 without departing from the scope of the present invention. Moreover, in the current exemplary embodiment, axially placed holes 4 are arranged to conform to the overall shape of the tip collar 1 to maximize space. However, the axially placed holes 4 can be arranged in a shape that is independent on the overall shape of the tip collar 1 without departing from the scope of the present invention. The axially placed holes may be cylindrical.

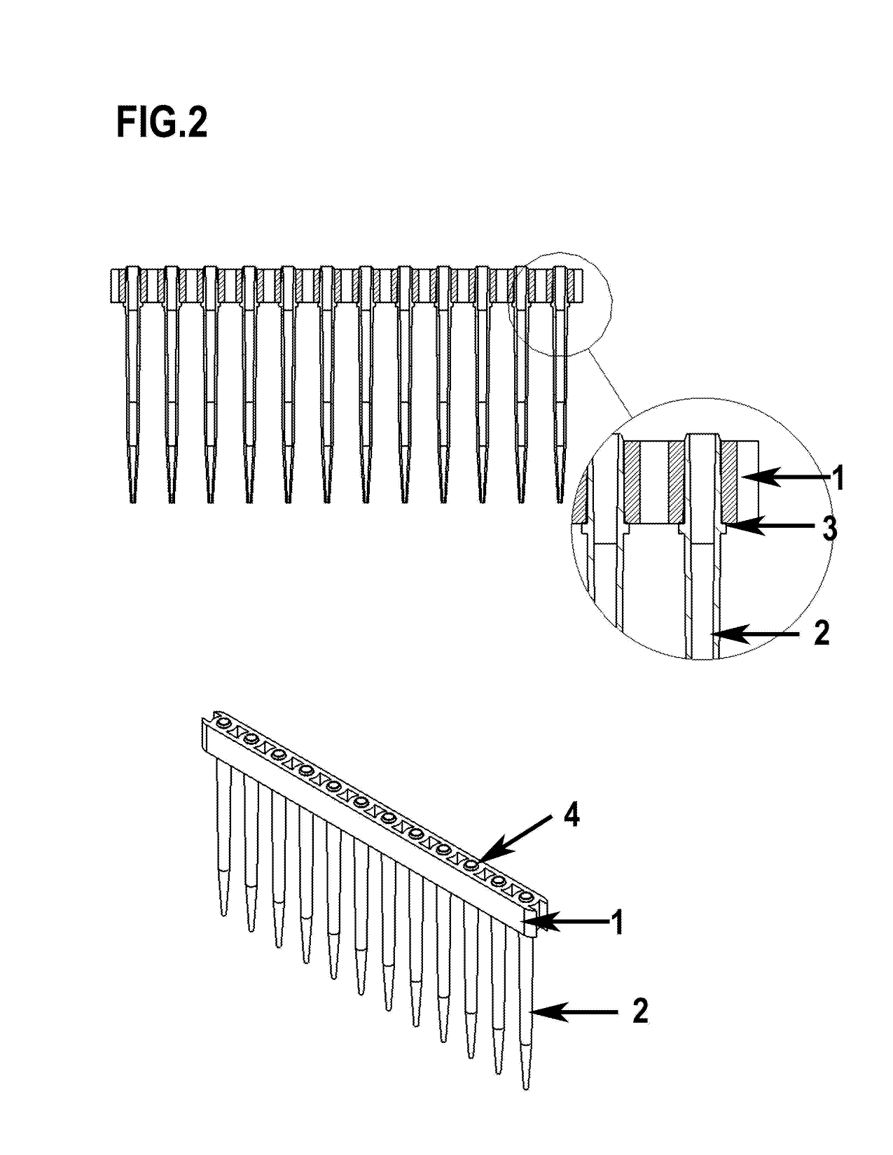

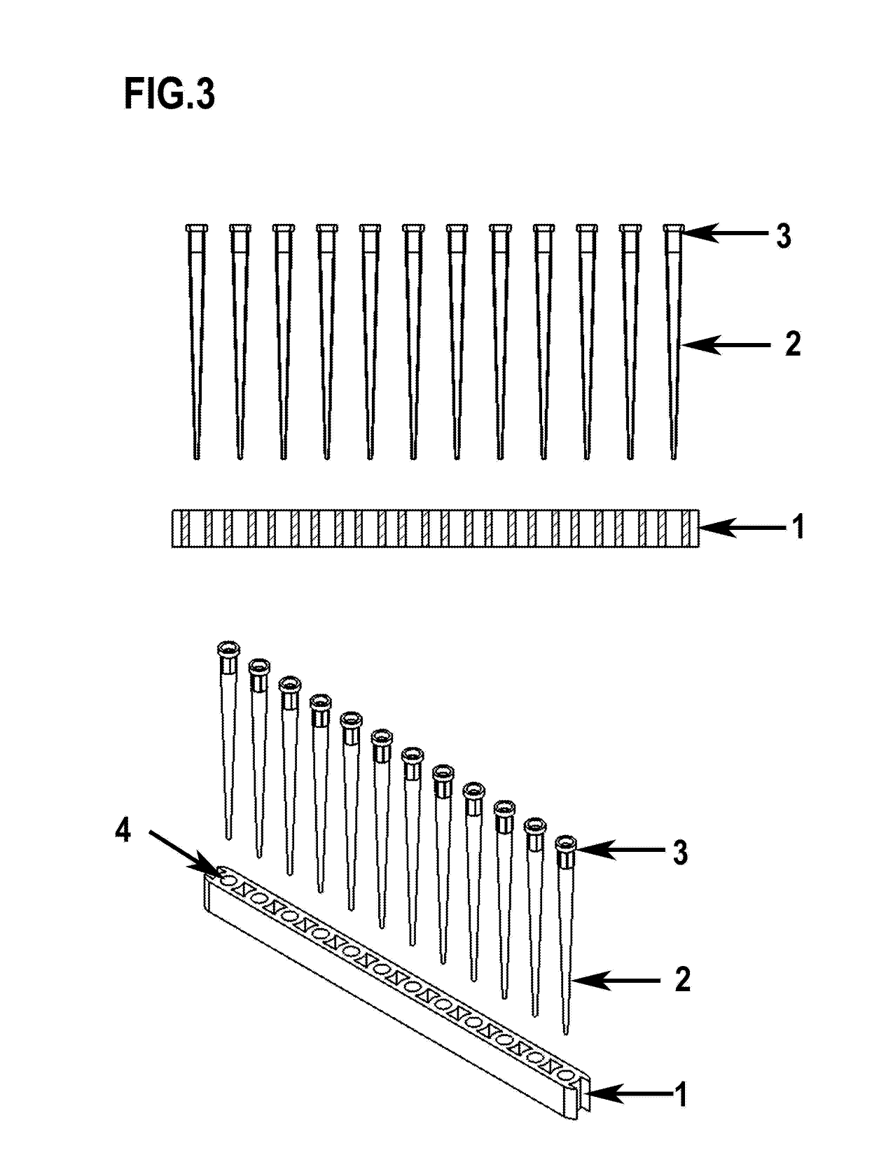

FIG. 2 shows a cutaway side view and close-up of the current invention where the pipette tips 2 have been installed into the axially placed holes 4 of the collar 1. The pipette tips 2 have been shown here as a plurality of pipette tips 2 to show the interrelationship between the plurality of pipette tips 2 and the axially placed holes 4 of the tip collar 1, resting on the shoulder flanges 3. The plurality of pipette tips 2 are shown here to be connected to the tip collar 1. In this embodiment the pipette tips 2 are of the externally-sealed type. The external diameter of the plurality of pipette tips 2 matches the internal diameter of axially placed holes 4. In the current embodiment, the tip collar 1 fits itself near the top surface of plurality of pipette tips 2 to achieve the desired structural rigidity. Having the tip collar 1 closer to the point of seal at the top surface of plurality of the pipette tips 2 provides extended structural rigidity to the plurality of pipette tips. However, as shown later in FIG. 3, traditional internally sealed pipette tips can also be used in a different method without departing from the scope of the present invention.

FIG. 3 shows another embodiment of the current invention allowing the tip collar 1 to be connected to traditional internally sealed pipette tips 2 by dropping the pipette tips 2 into the axially placed holes 4 and using the shoulder flange 3 to determine the depth of travel when the top surface of the traditional internally sealed pipette tips 2 meet with the tip collar 1.

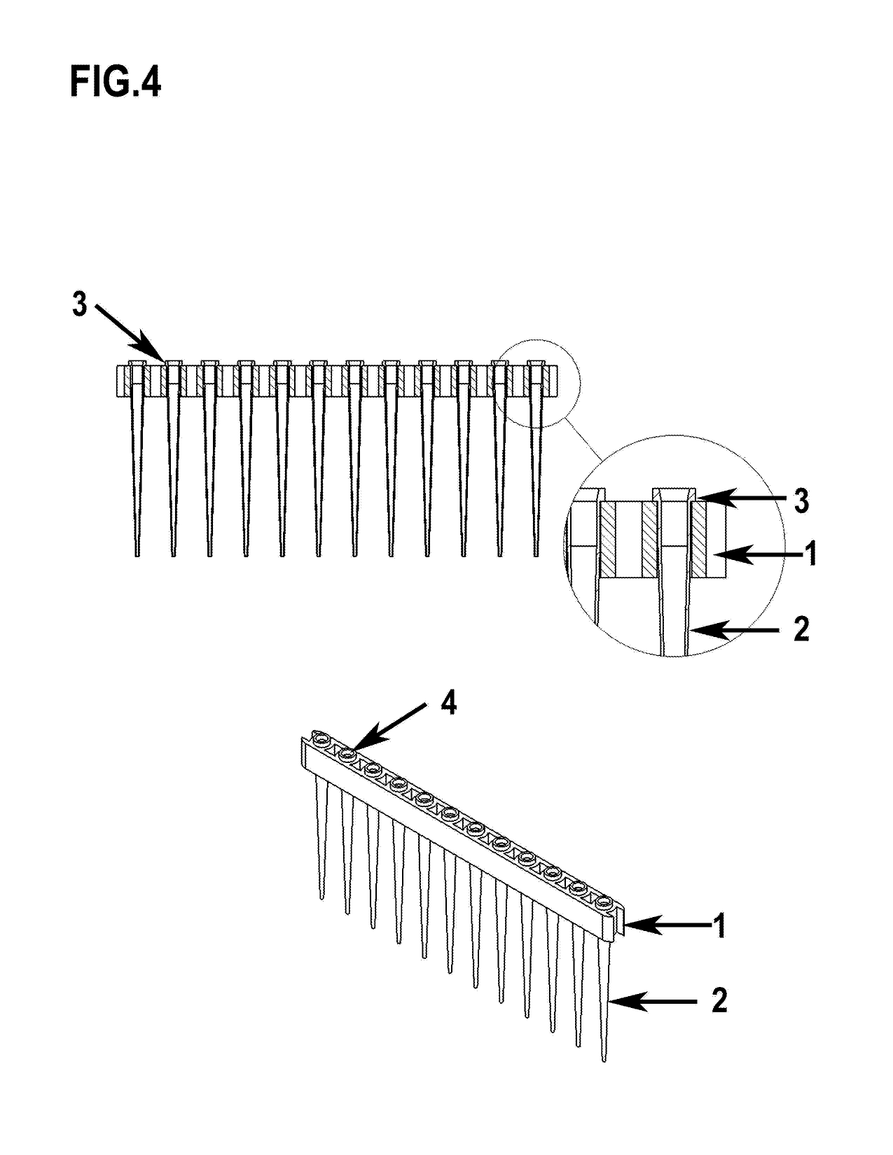

FIG. 4 shows a cutaway side view and close-up of the current invention where the internally sealed pipette tips 2 as described in FIG. 3 have been installed by dropping the pipette tips 2 into the axially placed holes 4 and using the shoulder flange 3 to determine the depth of travel when the top surface of the traditional internally sealed pipette tips 2 meets with the tip collar 1.

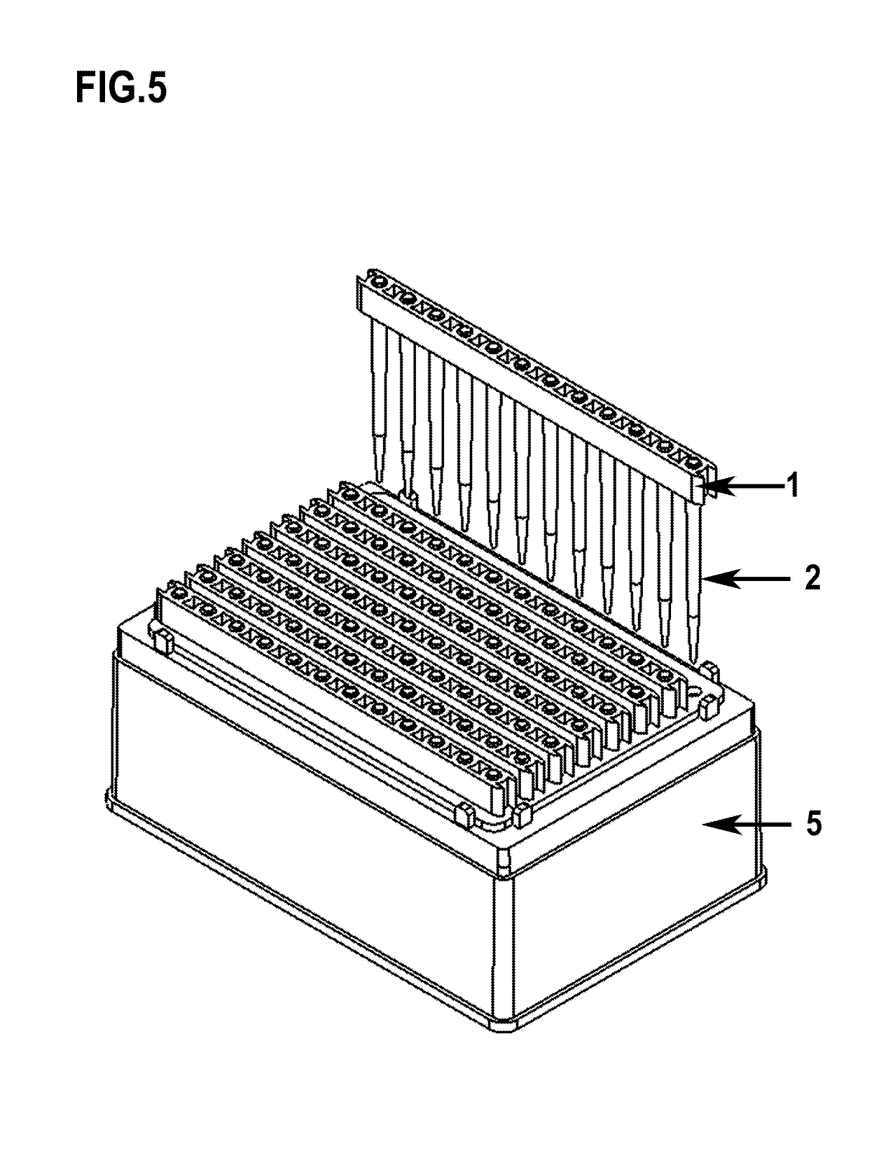

FIG. 5 shows a perspective view of the current invention as it is packaged and ready for use. The tip collar 1 and tips 2 are combined into the assembly as described in FIGS. 1-4. One such assembly is shown removed from the tip rack 5 and ready to be placed onto the pipettor head. The tip rack 5 is a disposable rack that holds multiple collar and tip assemblies for convenient storage and ease of access. The tip rack as described in this invention can hold varying numbers of collar/tip assemblies depending on the configuration of each collar.

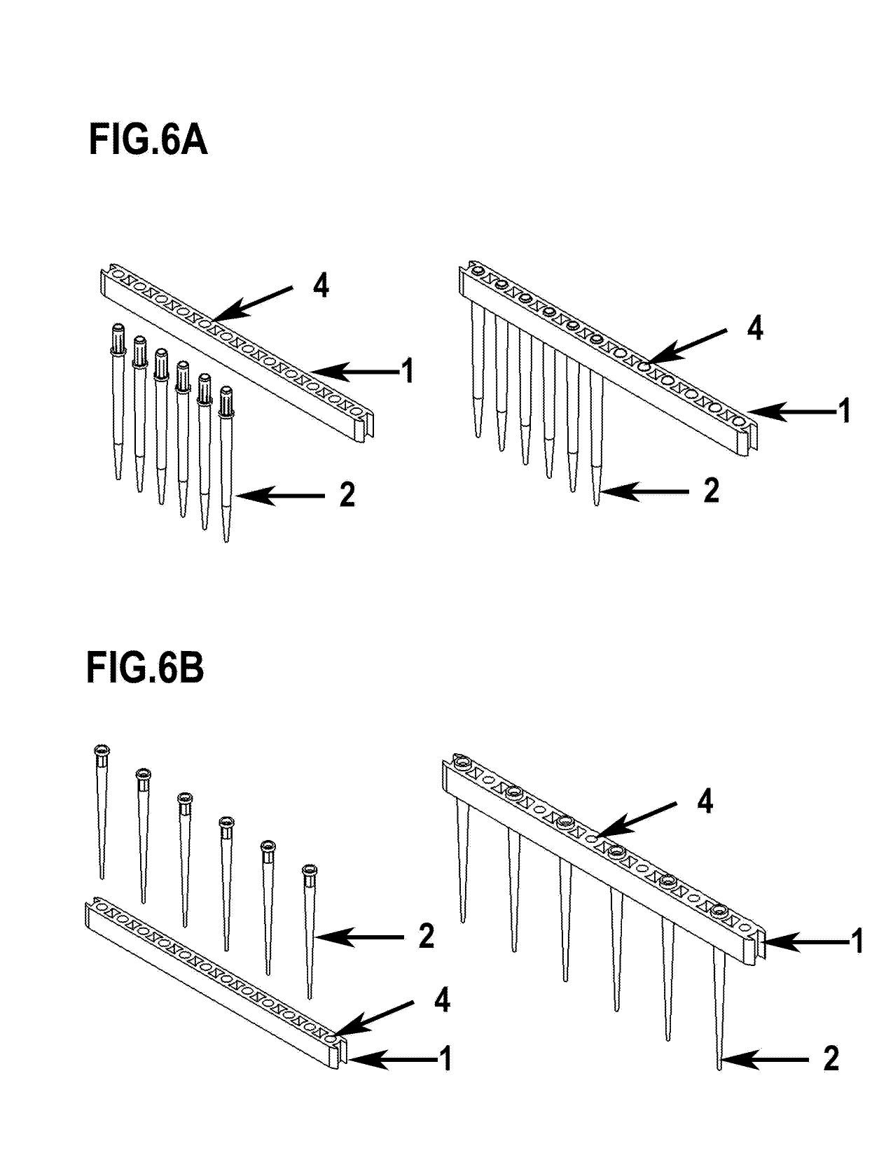

FIGS. 6A and 6B respectively show perspective views of the collar 1 and tips 2 in both embodiments previously discussed. In FIG. 6A the tips are loaded from the bottom, and in FIG. 6B the tips are loaded from the top. FIGS. 6A and 6B illustrate how the user can easily select a customized single line of pipette tips 2 according to the experiment they need to perform. The pipette tips 2 are easily removable from the collar 1 by the user. FIG. 6A shows how the user would configure the tips 2 and collar 1 assembly so that only one half (6) of the tips are used for the pipetting by loading the first 6 tips and leaving the rest of the axially places holes 4 in the collar 1 empty. FIG. 6B shows how a user would configure the tips 2 and the collar 1 assembly so that every other tip is loaded, and every other axially placed hole 4 position left blank. These are only two examples and it should be obvious that the user can configure any combination from one to all of the pipette tips 2 into the collar 1 as needed for their experiment. In addition, the same flexibility of design allows the manufacturer to easily configure the assembly of the tips 2 and collar 1 into other layouts besides all of the tips in a line, as might be needed to present to the market for specialized applications.

The invention is an entirely new and novel way to manufacture and provide pipette tips in a single line as needed for specialized applications in liquid handling, including but not limited to serial dilutions. One advantage is that unlike the current art the user can utilize the preconfigured single line of pipette tips without the need to manually load individual pipette tips to the pipettor from a loose pack.

Another advantage is that the design of the tip collar is such that when the tips are loaded they will be in perfect alignment with each other as far as depth, and they will also be straight rather than positioned at random angles; both of these are requirements for optimal pipetting results.

Yet another advantage is that the use can utilize the single line of pipette tips in a ready-to-use preconfigured package and the user does not need to touch the pipette tips; this reduces the chance for the contamination of the tips which could negatively impact the experimental results when the pipettor is used.

Yet another advantage is that the rigid tip collar in combination with the tips can be interfaced to a pipettor and achieve a seal which is required for optimal pipetting, without excessive force applied to load the tips. This simplifies the tip loading process and reduces the chance of user injury due to repetitive stress manual operations. This also greatly reduces the chance that pipette tips will break due to the force required for the tip loading process as is common with the prior art.

Yet another advantage is that the user can easily manipulate the single line of tips by removing any tips as desired in order to produce a pattern as required for specialized liquid handling operations.

1. I claim a tip collar for assembling together a plurality of pipette tips in a single line configuration each having a shoulder flange comprising:
a plurality of axially placed holes in a single line on said tip collar adaptable to receive said plurality of pipette tips in a single line;
wherein said tip collar allows said plurality of pipette tips to rigidly rest therein by forming an assembly set of pipette tips, wherein said assembly of pipette tips and said pipettor are connected by an upward lifting force exerted on a shoulder flange of each of said plurality of pipette tips.

2. I claim the tip collar of claim 1, wherein this tip collar and associated tips can be loaded onto either a manually-operated or automatically-operator pipettor.

3. I claim the tip collar and tips of claim 1 to be easily manufactured as disposable items, allowing them to be used at economical cost and disposed of after use in order to prevent cross-contamination.

4. I claim the tip collar and tips of claim 1 are independent entities, therefore allowing easy assembly of the tips into a single line within the collar OR allowing a different configuration within a single line by varying the placement of the tips.
